(19) United States
(12) Patent Application Publication
(10) Pub. No.: US 2007/0055533 A1
(43) Pub. Date: Mar. 8, 2007

(54) Method for protection and licensing of designs

(76) Inventors: Martin Kleen, Neunkirchen (DE); Jan Boese, Eckental (DE)

Correspondence Address: SCHIFF HARDIN, LLP;PATENT DEPARTMENT, 6600 SEARS TOWER, CHICAGO, IL, 60606-6473, US

(21) Appl. No.: 11/208,194

(22) Filed: Aug. 19, 2005

(51) Int. Cl. G06Q 99/00

(52) U.S. Cl. 705/1

(57) ABSTRACT

A method for protecting a custom design of a product provides that a manufacturer of the custom designed product agrees not to make the product according to the design for others in return for a payment from the designer. The protection, which is between the manufacturer and the designer, may be for identical designs or for designs having a scope of similarity. The payment for the protection may be a one time payment or may be periodic. The manufacturer may in some instances license the design to others and pay the designer a fee for doing so.

### BACKGROUND OF THE INVENTION

1. Field of the Invention

The present invention relates generally to a method for protecting product designs, and in particular to a method whereby a manufacturer agrees not to manufacture a custom designed product for others in return for payment from the designer.

2. Description of the Related Art

Manufacture of custom designed products is available from a variety of sources, many of them over the Internet. The custom products are manufactured according to customer requirements and are adapted to the specific needs of the customer. The custom product design may be individually specified by the customer over the Internet and then is produced and delivered to the customer in what is generally a one-time manufacture of the design. An example of a custom designed product is doorknobs.

Since the customer specifies the design of the product, the vendor is relieved of the task of designing the custom product. Thus, there are advantages for the vendor. The customer also has an advantage in that the customer gets a one of a kind product.

The foregoing process does not, however, offer protection of the custom design provided by the customer. Further, the custom designed product has not been made usable for further business.

### SUMMARY OF THE INVENTION

The present invention provides a method for protecting a design submitted to a manufacturer from being reproduced. Where an arrangement has been made for a customer to submit a custom design to a manufacturer for manufacture of a custom product, the present method provides that a separate arrangement is made between the customer and the manufacturer wherein the manufacturer promises not to manufacture the custom design for others. This separate arrangement may be accompanied by a payment for the promise.

### BRIEF DESCRIPTION OF THE DRAWINGS

FIG. 1 is a block diagram showing an embodiment of a method according to the principles of the present invention.

### DETAILED DESCRIPTION OF THE PREFERRED EMBODIMENTS

The present invention provides a method for protection and licensing of design services. In particular, a design of a customer that is provided to a vendor is recognized as having a value as between the vendor and the customer.

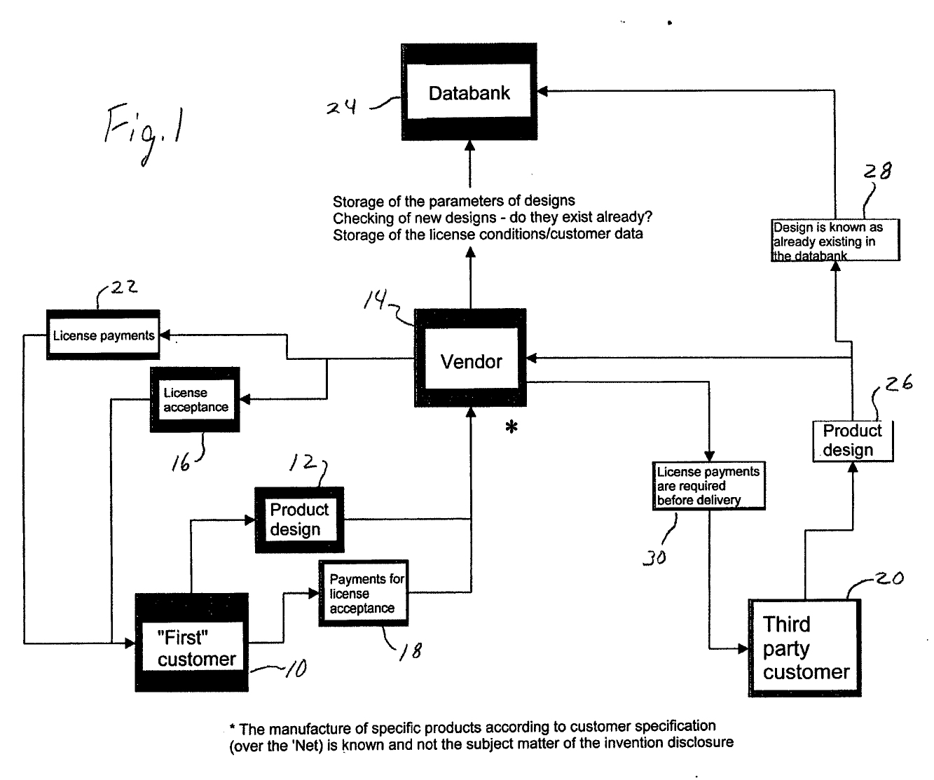

According to the known processes, a specification for a product, such as for a custom designed product, is provided by the customer to the vendor. In FIG. 1, the customer 10, here indicated as the first customer in this transaction, provides a product design 12 to the vendor 14. The specification or design 12 for the product may be provided over the Internet, in one embodiment. The product is then manufactured by the vendor 14 according to the design and is provided to the customer 10.

According to the present method, after receiving the design from the customer 10 or after being notified that a design will be forwarded to the vendor by the customer, the vendor 14 offers to have the design protected. The protection that is offered is protection from the manufacture of further products of an identical design or of very similar products by the vendor company 14. The protection is between the vendor 14 and customer 10 and does not transcend the “vendor boundaries.”

If the customer agrees to the design protection, the vendor promises not to manufacture products according to the design after the manufacturing run that was ordered by the customer. This is shown in the drawing of FIG. 1 by the license acceptance 16. The benefits of this arrangement are that the vendor 14 can obtain a cash benefit (such as a payment or other benefit) for this protection. The payment for the license acceptance is shown at 18. The customer 10 also receives the additional benefit of ensuring that the customer receives a one of a kind product. The present method thus separates the exclusivity of the design from the agreement to manufacture the product according to the design.

As important as providing protection against further manufacture of some product is the fact that other custom products need not be protected by the customer 10, thereby representing a cost savings to the customer 10 and enabling the vendor 14 to manufacture these unprotected products. This is a significant advantage over custom product manufacturing arrangements in which the cost of exclusivity is built in to the arrangement and not considered a separate commercial transaction between the parties.

According to an aspect of the present method, the protection offered by the vendor 14 is provided with a specified term that may be renewed by the customer if so desired. For example, the protection offered by the vendor can be renewed by the customer making intermittent (for example, yearly) payments 18 to the vendor. The periodic payments permit the customer 10 to cease making payments and thereby cease the protection of a product that is no longer of interest, representing a further potential savings to the customer 10. Alternatively, the protection may be purchased by the customer 10 on a more permanent basis, such as for the lifetime of the company (either the customer company or the vendor company) by making a larger payment 18.

An advantage of the present method is that a price differentiation can be provided for protection of various classes of goods to be sold. The prices of custom, one of a kind goods are set higher and so are sold at a higher price to the public, and so both the designer/customer 10 and the manufacturer 14 realize a benefit from the exclusivity. On the other hand, goods which may be available though the manufacturer to other sources and are therefore not exclusive may be priced lower since the designer/customer 10 is not paying the manufacturer 14 to protect the design.

The price differentiation may extend to the scope of the protection offered under this method. For example, a lower price may be paid for protection against further manufacture of goods that are identical, or exactly the same, as the custom products. This lower price is possible since the manufacturer 14 will rarely receive custom designs from two customers that are the same and so this narrower definition of the protected goods will have little impact on the manufacturer's business.

A higher price may be demanded by the manufacturer 14 for protection against further manufacture of not only the same design but also similar designs. This has a more restrictive impact on the manufacturer's business, so the greater price is justified for the manufacturer to take on this arrangement. The present method provides that the degree of similarity should be defined in any such agreement restricting designs having a scope of similarity.

According to an embodiment of the present method, a sliding price differentiation is implemented for the protection. The customer can set the degree of the protection on a sliding scale. A higher degree of protection means a far wider interpretation of the similarity parameter. In other words, a wide interval is established around the similarity parameter. Lesser protection means a very narrow interval around the similarity parameter. By selection of the degree of protection, the customer also individually selects the price that the customer pays for the protection. The more the customer pays, the greater the protection and the greater as well the probability to obtain licensing payments (when the customer chooses this model).

As a further step, the vendor 14 can offer to the customer 10 to license the design to further customers 20. The vendor 14 thus offers third parties (other customers) 20 that the manufacturer 14 will manufacture products according to the one-time design of the first customer 10. If the third party customer 20 accepts this arrangement, the vendor 14 receives additional business and so the vendor 14 pays the first customer 10 a license fee 22 for this. Thus, the payments may flow the other direction as well according to the present method.

As a further embodiment of the method, the vendor 14 can buy particularly successful designs from the first customer 10 outright for a one-time payment in order to offer them to third parties 20 for their own account.

The establishment of the similarity of the design of two products is possible via derivation of model parameters. Since the design of the product ensues electronically (on the computer, for example, using computer aided design software), the information exists digitally. Size and shape of the product are known. Among other things, the following would be conceivable as parameters for a similarity determination. One similarity parameter may be the surface ratio of a color area on the product to the total surface. Another similarity parameter may be the angularity or roundness of borders of the color areas on the product. A further similarity parameter can include the contour to area ratio of features on the product. For example, stripes have a lot of contour with little area, whereas a circle has little contour with a lot of area. Yet another area of similarity parameter is if the vendor offers the use of specific “set pieces” such as a pattern which is used via simple selection of the product, this set piece may be used as a parameter for similarity. Of course, other parameters of similarity are also envisioned and are within the scope of the present invention.

The similarity measurements for the designed product may be stated as mathematical parameters derived from shaping, coloring or like features of a designed product. The similarity of one product to another can thus be summarized in numbers. The similarity determination limitations may place limits on the relatedness of the products by setting numerical limits.

Given each design process of a new product, the product is checked as to whether this model has already been assigned. For example, in the FIG. 1, the design parameters of a design provided by the customer 10 are submitted by the vendor 14 to a database 24 of the protected designs. If the design by the third part is protected, the manufacturer offers to manufacture the product only if the first customer has agreed to license the design (however, otherwise it is refused).

In FIG. 1, the third party customer 20 may present a product design 26 to the vendor 14 for a proposed manufacture. The design 26 is submitted not only to the vendor 14 but also to the database 24 of protected products as indicted at 28. If the design is identical or sufficiently similar to a design in the database 24 that it is a protected design and if the vendor 14 is permitted under the protection agreement to license the design, the vendor 14 will require a license payment 30 from the third party customer 20. The vendor 14 may be required to forward a license payment 22 to the first customer 10 according to the arrangements between the first customer 22 and the vendor 14.

Some advantages for the vendor have been set forth in the foregoing. Additional advantages are provided as well. In particular, the vendor can acquire some of the creative potential of the customers. The vendor may offer an exclusive service that is valued at a high price. The vendor can also offer a product whose uniqueness (if desired, a lifelong uniqueness) is guaranteed, this corresponding to the payment or price. Lastly, the vendor may offer to take over the license for the customer. The customer can foster the hope to earn money with the one of a kind design. The customer would if anything want to make use of the high-priced service.

Advantages are provided for the customer in addition to those set forth above. The customer receives an individual product whose design is protected. The customer receives the certainty that the customer possesses a unique product. If the customer has determined to not protect the design, the customer may receive licensing revenue for the design.

The customer is generally the designer of the customer product or is responsible for the design, such as by hiring a designer, whether an individual, group, or company, to provide the design. The customer may provide the completed design to the manufacturer, but in other instances the design may be revised, changed, completed or otherwise worked on by the manufacturer.

Thus, there is shown and described a method whereby a customer who has designed a custom design may protect the design against reproduction by the manufacturer of the custom product.

Although other modifications and changes may be suggested by those skilled in the art, it is the intention of the inventors to embody within the patent warranted hereon all changes and modifications as reasonably and properly come within the scope of their contribution to the art.

We claim:

1. A method for protection of a custom product, comprising the steps of:
receiving a custom design from a customer for manufacture of the custom product;
manufacturing the custom product according to the custom design for the customer;
proposing protection of the custom design by the manufacturer to the customer;
agreeing to not manufacture the custom design for others if the proposed protection is accepted by the customer; and
accepting payment from the customer for the protection.

2. A method as claimed in claim 1, wherein said customer is a designer of the custom design.

3. A method as claimed in claim 1, wherein said step of accepting payment includes accepting a single payment from the customer for the protection.

4. A method as claimed in claim 1, wherein said step of accepting payment includes accepting periodic payments from the customer for the protection, a period of said periodic payments corresponding to a period of the protection.

5. A method as claimed in claim 4, wherein said periodic payment is once a year.

6. A method as claimed in claim 1, wherein the protection is for identical products to the custom design.

7. A method as claimed in claim 1, wherein the protection is for similar products to the custom design.

8. A method as claimed in claim 7, further comprising the step of: determining a measure of similarity to the custom design, said measure of similarity being numerically defined.

9. A method as claimed in claim 1, wherein the protection offered is for identical products at a first price or for similar products at a second price, said second price being higher than said first price.

10. A method as claimed in claim 1, further comprising the step of:
manufacturing products according to the custom design for others if the customer does not agree to the protection.

11. A method as claimed in claim 1, further comprising the steps of:
offering the custom design to others; and
paying a license fee to the customer upon acceptance of the custom design by the others.

12. A method for protecting a design of a product, comprising the steps of:
providing a custom design to a manufacturer for manufacture of a product according to the custom design;
receiving an offer for protection against the manufacturer making a product according to the custom design for others;
paying a fee to the manufacturer for the protection; and
receiving an exclusive product according to the custom design from the manufacturer.

13. A method as claimed in claim 12, wherein said step of paying the fee is for protection against manufacture of identical products according to the custom design by the manufacturer.

14. A method as claimed in claim 12, wherein said step of paying the fee is for protection against manufacture of similar products to the custom design by the manufacturer.

15. A method as claimed in claim 12, further comprising the step of:
accepting a license fee from the manufacturer for manufacture of the custom design for others.

16. A method as claimed in claim 12, wherein said step of paying the fee includes paying a periodic fee.

17. A method for manufacturing a plurality of custom products, comprising the steps of:
submitting designs for the plurality of custom products to a manufacturer;
receiving offers to protect the designs against manufacture for others by the manufacturer;
paying to the manufacturer a fee for protection of at least one of the designs;
refusing the protection for at least another of the designs; and
receiving an exclusive product according to said at least one of the designs from the manufacturer.

18. A method as claimed in claim 17, wherein said step of paying includes a periodic payment.

19. A method as claimed in claim 18, further comprising the step of: halting the periodic payment to the manufacturer.

20. A method as claimed in claim 17, further comprising the step of:
receiving a license fee from the manufacturer for said at least another of the designs upon manufacture of said at least another of the designs by the manufacturer for a third party.
